(19) United States
(12) Patent Application Publication
(10) Pub. No.: US 2010/0123918 A1
(43) Pub. Date: May 20, 2010

(54) IMAGE FORMING APPARATUS AND PROGRAM

(75) Inventor: Naoaki Matsuo, Suwa-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/620,395

(22) Filed: Nov. 17, 2009

(30) Foreign Application Priority Data
Nov. 19, 2008 (JP) 2008-295715

(51) Int. Cl. G06F 15/00; H04N 1/40

(52) U.S. Cl. 358/1.13; 358/443

(57) ABSTRACT

Provided is an image forming apparatus which is connected to a storage unit for storing a plurality of image data so as to form an image using image data selected by a user from the plurality of image data stored in the storage unit, the image forming apparatus including: a display unit which displays a screen; an exclusion candidate image extracting unit which extracts exclusion candidate image data as a candidate excluded from image formation with a predetermined condition from image-formed image data out of the image data stored in the storage unit; an exclusion image selection reception unit which displays the extracted exclusion candidate image data by the display unit and receives selection of image data excluded from image formation by the user; an exclusion image setting unit which sets the selected image data as exclusion image data excluded from image formation; and a formed image selection reception unit which displays image data excluding the image-formed image data and the set exclusion image data from the plurality of image data stored in the storage unit on the display unit and receives selection of image data for image formation by the user, when an image forming instruction is received from the user.

### BACKGROUND

1. Technical Field

The present invention relates to an image forming apparatus and a program and, more particularly, to an image forming apparatus connected to a storage unit for storing a plurality of image data so as to form an image using image data selected by a user among the plurality of image data, and a program for allowing one or a plurality of computers to function as an image forming apparatus.

2. Related Art

In the related art, an apparatus for selecting an image from a plurality of image data stored in a storage medium such as a hard disk of a computer by the operation of a user and displaying the image on a liquid crystal display is suggested (for example, see JP-A-2004-193700). In this apparatus, firstly, the thumbnails of all image data of a specified file are displayed on a candidate area. A user selects which of the thumbnails on the candidate area by clicking and clicks a switching button such that image data corresponding to the selected thumbnail is moved to an out-of-candidate area. In addition, by finally selecting one thumbnail in the candidate area, the image data corresponding to the selected thumbnail is displayed in a working field. As a result, since an operator can finally select one image data narrowed down from the plurality of image data in advance, it is possible to enhance the workability.

However, since the narrowing down of the image data is performed by the operation of the user, the burden on the user may be increased. Recently in particular, with large capacity of recording media, the number of storable image data is increased. Thus, the above-described problem is increased.

### SUMMARY

An advantage of some aspects of the invention is that it provides an image forming apparatus and program, which is capable of enhancing the ease of selecting an image to be formed from a plurality of image data.

The image forming apparatus and the program of the invention employ the following units in order to achieve the above-described advantages.

According to an aspect of the invention, there is provided an image forming apparatus which is connected to a storage unit for storing a plurality of image data so as to form an image using the image data selected by a user from the plurality of image data stored in the storage unit, the image forming apparatus including: a display unit which displays a screen; an exclusion candidate image extracting unit which extracts exclusion candidate image data as a candidate excluded from image formation with a predetermined condition from image-formed image data out of the image data stored in the storage unit; an exclusion image selection reception unit which displays the extracted exclusion candidate image data by the display unit and receives selection of image data excluded from image formation by the user; an exclusion image setting unit which sets the selected image data as exclusion image data excluded from image formation; and a formed image selection reception unit which displays image data excluding the image-formed image data and the set exclusion image data from the plurality of image data stored in the storage unit on the display unit and receives selection of image data for image formation by the user, when an image forming instruction is received from the user.

In the image forming apparatus of the invention, the exclusion candidate image data is extracted as the candidate excluded from image formation with the predetermined condition from image-formed image data out of the image data stored in the storage unit, the extracted exclusion candidate image data is displayed by the display unit and the selection of the image data excluded from the image formation by the user is received, the selected image data is set as exclusion image data excluded from the image formation, and image data excluding the image-formed image data and the set exclusion image data from the plurality of image data stored in the storage unit is displayed on the display unit and selection of the image data for image formation by the user is received when an image forming instruction is received from the user. In this way, since the image data for image formation can be narrowed down without laying an excessive burden on the user, it is possible to further improve the ease of selecting the image data for the image formation.

In the image forming apparatus in which a plurality of image data is collected and selected from the plurality of image data stored in the storage unit and the image formation can be performed using the selected plurality of image data, the exclusion candidate image extracting unit and the exclusion image selection reception unit may be performed with respect to the image-formed image data whenever image formation is completed with respect to one image data or with respect to the image-formed image data after the image formation is complete with respect to all the selected image data. According to the former image forming apparatus, the user can sequentially select the exclusion image data from the image-formed data without waiting for the completion of the formation of all the selected images. According to the latter image forming apparatus the user can collectively select the exclusion image data with respect to the plurality of image-formed image data.

In the image forming apparatus of the invention, the formed image selection reception unit may be able to extract the image data coincident with the selected image data in the predetermined condition from the image data stored in the storage unit, to display the extracted image data on the display unit, and to change the selection from the selected image data to the extracted image data, before selection is decided, even when the image data is selected by the user. In this way, the user can select an image better without laying a burden on an operation. In the image forming apparatus of the invention, the exclusion candidate image extracting unit may use data which is extracted as the image data coincident with the selected image data in the predetermined condition as the exclusion candidate image data. In this way, it is possible to set the exclusion image data even before the selection of the image data for image formation is decided.

In the image forming apparatus of the invention, the formed image selection reception unit may be able to select at least one of the entirety of the image data stored in the storage unit that is displayed, the display of the image data excluding only the image-formed image data, the display of the image data excluding only the set exclusion image data, the display only the image-formed image data, and the display of the exclusion image data. In this way, it is possible to further increase the degree of freedom in the selection when the image data for image formation is selected by the user.

In the image forming apparatus of the invention, the predetermined condition may be a condition similar to the image-formed image data. In this way, it is possible to suppress the display of similar image data when the image data for image formation is selected and to further improve the ease of selecting of an image.

In the image forming apparatus of the invention, the image forming apparatus may be constituted as a printing apparatus for performing printing using the selected image data.

According to another aspect of the invention, there is provided a program for allowing one or a plurality of computers to function as the image forming apparatus of the invention, that is, the image forming apparatus which is connected to a storage unit for storing a plurality of image data so as to form an image using image data selected by a user from the plurality of image data stored in the storage unit, the image forming apparatus including: a display unit which displays a screen; an exclusion candidate image extracting unit which extracts exclusion candidate image data as a candidate excluded from image formation with a predetermined condition from image-formed image data out of the image data stored in the storage unit; an exclusion image selection reception unit which displays the extracted exclusion candidate image data by the display unit and receives selection of image data excluded from image formation by the user; an exclusion image setting unit which sets the selected image data as the exclusion image data excluded from image formation; and a formed image selection reception unit which displays image data excluding the image-formed image data and the set exclusion image data from the plurality of image data stored in the storage unit on the display unit and receives the selection of the image data for image formation by the user, when an image forming instruction is received from the user.

According to the program of the invention, the effect of the image forming apparatus of the invention, for example, the effect in which it is possible to further improve the efficiency of searching for the image data that is selected for image formation without laying an excessive burden on the user, can be obtained. This program may be recorded on a computer-readable recording medium (for example, a hard disk, a ROM, a FD, a CD, a DVD or the like), may be transferred to a computer to another computer via a transfer medium (a communication network such as the Internet or a LAN), or may be transmitted or received in other formats.

### BRIEF DESCRIPTION OF THE DRAWINGS

The invention will be described with reference to the accompanying drawings, wherein like numbers reference like elements.

FIG. 1 is an appearance view and a block diagram of a multifunction printer.

FIG. 2 is a flowchart showing an example of a printing process routine.

FIG. 3 is an explanatory view showing an example of a photo selection screen.

FIG. 4 is a flowchart showing an example of a similar photo searching process.

FIG. 5 is an explanatory view showing an example of a printing excluding selection screen.

FIG. 6 is a flowchart showing an example of a display list preparing process.

FIG. 7 is an explanatory view showing an example of a narrowing condition selection screen.

FIG. 8 is a flowchart showing an example of a printing list changing process.

### DESCRIPTION OF EXEMPLARY EMBODIMENTS

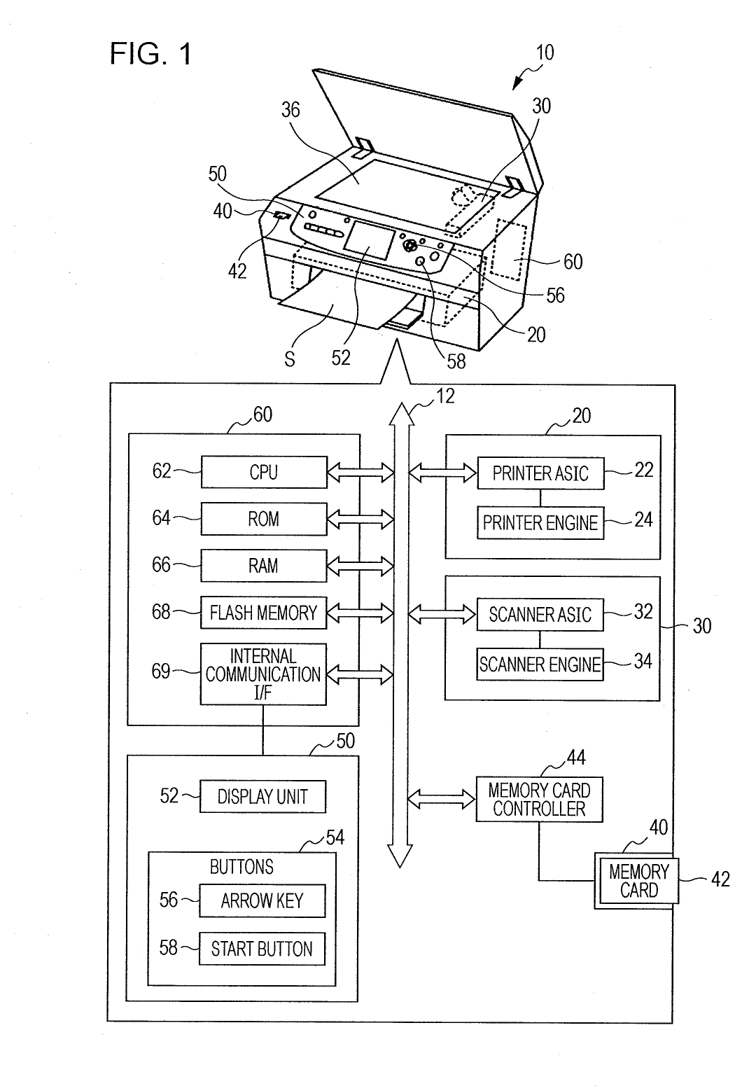

Next, the embodiments of the invention will be described with reference to the accompanying drawings. FIG. 1 is an outline view and a block diagram showing the schematic configuration of a multifunction printer 10 according to an embodiment of an image processing apparatus of the invention.

As shown in FIG. 1, the multifunction printer 10 of the present embodiment includes a printer unit 20 for executing printing on paper S based on a printing job, a scanner unit 30 for reading a document placed on a glass platen 36, a memory card controller 44 for inputting/outputting data to/from a memory card 42 inserted into a memory card slot 40, an operation panel 50 for displaying a variety of information on a display unit 52 or inputting the instruction of a user by the operation of buttons 54, and a main controller 60 for performing the whole control of the apparatus. The multifunction printer 10 is configured such that the printer unit 20, the scanner unit 30, the memory card controller 44, and the main controller 60 exchange a variety of control signals or data via a bus 12.

The printer unit 20 includes a printer ASIC 22 and a printer engine 24. The printer ASIC 22 is an integrated circuit for controlling the printer engine 24, and controls the printer engine 24 to perform printing on paper S based on an image file which is an object of a printing instruction, when receiving the printing instruction from the main controller 60. In addition, the printer engine 24 is composed of a known ink jet type color printer mechanism for performing printing by ejecting an ink from a printing head onto paper. The ASIC is abbreviated from Application Specific Integrated Circuit.

The scanner unit 30 includes a scanner ASIC 32 and a scanner engine 34. The scanner ASIC 32 is an integrated circuit for controlling the scanner engine 34, and controls the scanner engine 34 to read a document placed on the glass platen 36 as image data when receiving a scanning instruction from the main controller 60. The scanner engine 34 is composed of a known image scanner and includes a known color image sensor for decomposing light reflected after emitting light toward the document into colors of red (R), green (G) and blue (B) and using the colors as scanning data.

The memory card controller 44 inputs/outputs data to/from the memory card 42 inserted into the memory card slot 40 placed next to the operation panel 50. This memory card controller 44 reads a file stored in the memory card 42 and transmits the file to the main controller 60 or inputs a command from the main controller 60 and writes data in the memory card 42 based on the command, when the memory card 42 is connected to the memory card slot 40.

The operation panel 50 includes a display unit 52 and buttons 54. The display unit 52 is a liquid crystal display and displays the selection of various modes, the setting of the printing, and a printing preview screen. The buttons 54 includes arrow keys 56 of all directions operated during the selection of various modes or the setting of various operations, a decision button for deciding various operations, a start button 58 pressed when an image is printed, and a power source button operated when the power is turned on or off, and inputs the instruction of the user to the main controller 60 via an internal communication interface 69. As various selectable modes, there is a printing mode for selecting and printing an image stored in the memory card 42, a scanning mode for reading and storing a document placed on the glass platen 36 in the memory card 42 as image data, a copy mode for reading and copying a document, and the like.

The main controller 60 is composed of a microprocessor including a CPU 62, includes a ROM 64 for storing a variety of processing programs, a variety of data, a variety of table and the like, a RAM 66 for temporarily storing scanning data, printing data or the like, an electrically rewritable flash memory 68 for holding data when the power is turned off, and the internal communication interface 69 for performing the communication of the operation panel 50, all of which are connected so as to exchange a signal via the bus 12. The main controller 60 inputs various operation signals or various detection signals from the printer unit 20, the scanner unit 30 or the memory card controller 44 or inputs an operation signal generated according to the operation of the buttons 54 of the operation panel 50. In addition, an instruction for reading the image data from the memory card 42 and outputting the image data to the main controller 60 is output to the memory card controller 44, an instruction is output to the printer unit 20 so as to print an image, an instruction is output to the scanner unit 30 so as to read a document placed on the glass platen 36 based on a scanning instruction of the buttons 54 of the operation panel 50, or a control instruction of the display unit 52 is output to the operation panel 50.

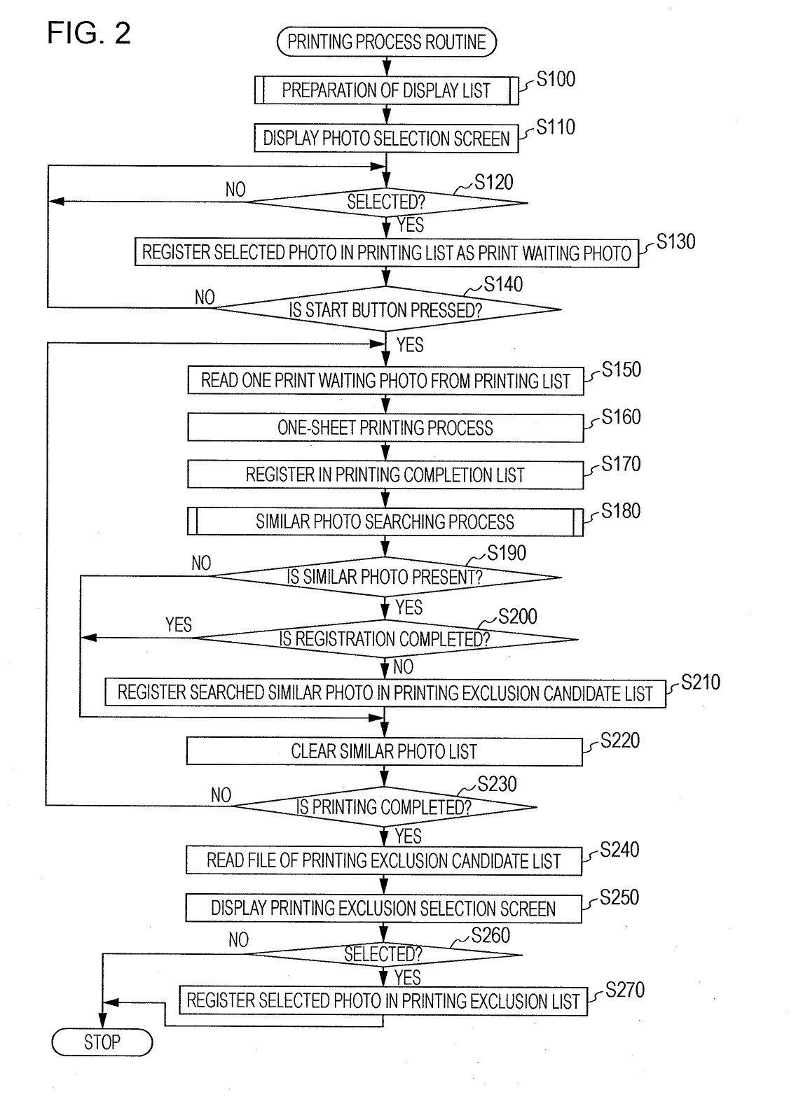

Next, the operation of the multifunction printer 10 of the present embodiment and, more particularly, the operation when an image stored in the memory card 42 is selected and printed will be described. FIG. 2 is a flowchart showing an example of a printing process routine executed by the main controller 60. This process is executed when the memory card 42 is inserted into the memory card slot 40 and a printing mode is selected as an operation mode.

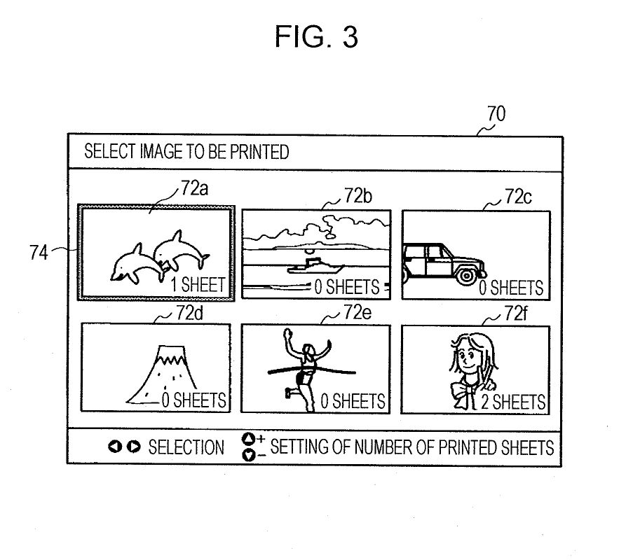

When the printing process routine is executed, in order to select an image file to be printed from the files stored in the memory card 42, a display list to be displayed on the display unit 52 is prepared (step S100), and a photo selection screen for reading files of the prepared display list and selecting a photo to be printed is displayed such that the selection of a photo is received from a user (S110). The preparation of the display list is performed by executing a display list preparation process, narrowing files to be displayed from the files stored in the memory card 42, and registering the files on the list. The display list preparation process is an important portion of the invention, but, for convenience of description, the detailed description thereof will be given later. The selection of the photo is performed using the photo selection screen 70 shown in FIG. 3. In the photo selection screen 70, as shown in FIG. 3, six thumbnail images 72a to 72f are arranged on one screen in a 2×3 matrix. In the present embodiment, the photo may be selected by operating the left and right keys of the arrow keys 56 and moving the position of a cursor 74. When a photo is selected, the number of printed sheets may be increased or decreased one by one with respect to the photo selected by operating the up and down keys of the arrow keys 56. When the left key of the arrow keys 56 is pressed in a state in which the cursor 74 is positioned at the upper left, preceding new six thumbnail images are displayed and, when the right key of the arrow keys 56 is pressed in a state in which the cursor 74 is positioned at the lower right, next six thumbnail images are displayed.

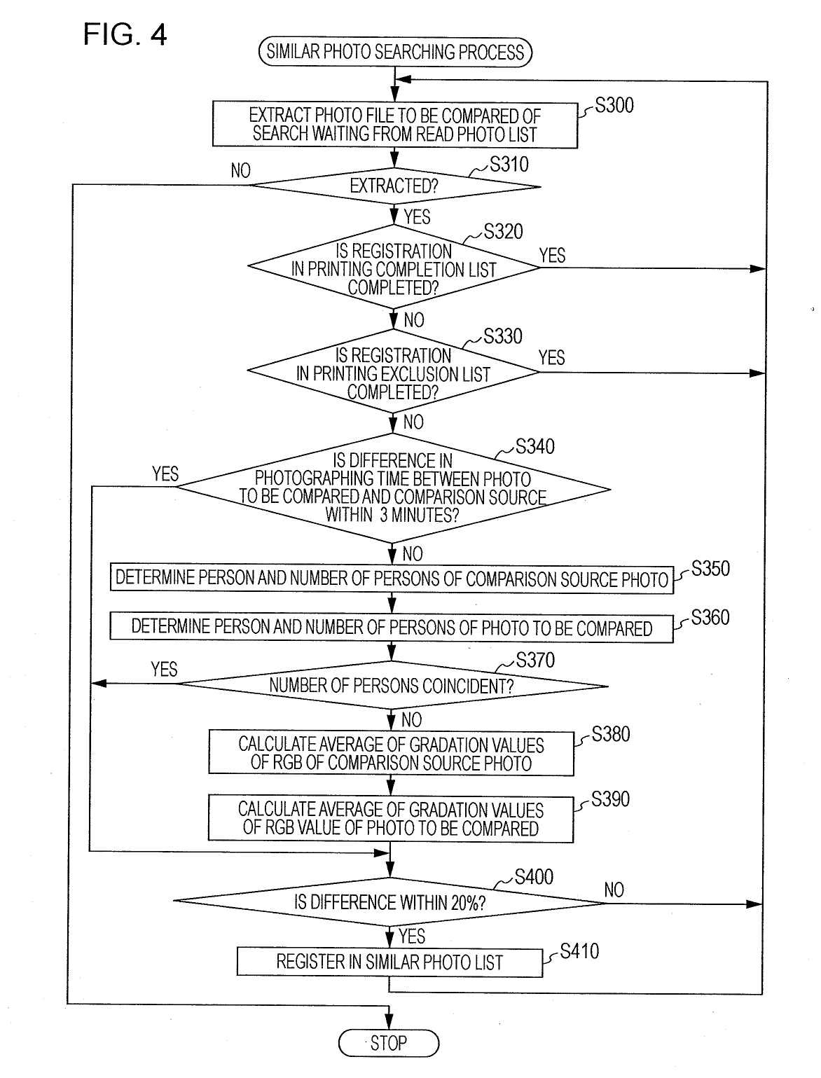

If the photo is selected by the user (step S120), the selected photo (file name) is registered in a printing list as a print waiting photo (step S130), and the start button 58 for instructing the start of the printing waits to be pressed (step S140). When the start button 58 is pressed, only one photo (image file) is read from the memory card 42 using the file name of the print waiting photo registered in the printing list (step S150), a printing process is executed based on one read photo (step S160), the processed photo (file name) is registered in a printing completion list when the printing process is completed (step S170), and a similar photo searching process shown in FIG. 4 for searching for similar photos to this photo is executed (step S180). Now, the description of the printing process routine will be interrupted and the similar photo searching process of FIG. 4 will be described.

In the similar photo searching process, the main controller 60 first extracts a photo file to be compared in a search waiting state from a read photo list (step S300). When the photo file to be compared is extracted (step S310), it is determined whether or not the extracted photo file to be compared is a photo registered in a printing completion list (step S320) and it is determined whether or not the extracted photo file is a photo registered in a printing exclusion list (step S330). In the read photo list, although described later, the file names of all the files stored in the memory card 42 are registered. When the photo file to be compared is registered in the printing completion list or the printing exclusion list, the photo file to be compared is set to searching completion, the process returns to step S300 of extracting a next photo file to be compared in the search waiting state, and the processes after step S310 are repeated. In contrast, when the photo file to be compared is not registered in the printing completion list and the printing exclusion list, the photographing time of the photo file to be compared and the photographing time of a comparison source photo file (a photo file which has been printed in step S160 of the printing process routine of FIG. 2) are compared such that it is determined whether the photo file to be compared is photographed within ±the predetermined time (for example, 3 minutes) of the comparison source photo file (S340). In the present embodiment, the photographing time used in this determination is read from that written in Exif information as one of photographing conditions along with the photographing of a digital camera. When the photo file to be compared is photographed within ±predetermined time of the comparison source photo file, it is determined that both files are similar, the file name of the photo file to be compared is registered in the similar photo list (step S410), the process returns to step S300 of extracting a next photo file to be compared in the search waiting state, and the processes after step S310 are repeated. When the photo file to be compared is not photographed within ±the predetermined time of the comparison source photo file, it is determined whether the comparison source photo is a photo of a person by a face recognition process, and the number of persons is checked (step S350), and it is determined whether the photo to be compared is a person photo by a face recognition process and the number of persons is checked (step S360). When both the comparison source photo and the photo to be compared are photos of people and the number of persons is coincident, it is determined that both photos are similar, the file name of the photo file to be compared is registered in the similar photo list (step s410), the process returns to step S300 of extracting a next photo file to be compared in the search waiting state, and the processes after step S310 are repeated. When any one of the comparison source photo and the photo to be compared is not a person photo or if both the comparison source photo and the photo to be compared are person photos but the number of persons is not coincident, an average of gradation values (luminance values) of all pixels configuring the comparison source photo is calculated with respect to each RGB (step S380), an average of gradation values of all pixels configuring the photo to be compared is calculated with respect to each RGB (step S390), and the averages of both photos are compared such that a difference therebetween is within a predetermined ratio (for example, 20% or the like) with respect to all RGB (step S400). When the difference between the averages is within the predetermined ratio, it is determined that both photos are similar, the file name of the photo file to be compared is registered in the similar photo list (step s410), the process returns to step S300 of extracting a next photo file to be compared in the search waiting state, and the processes after step S310 are repeated. As the result of repeating the process of steps S300 to S410, when the photo file to be compared in the search waiting state cannot be extracted in step S310, the present process is completed. Up to now, the similar photo searching process was described.

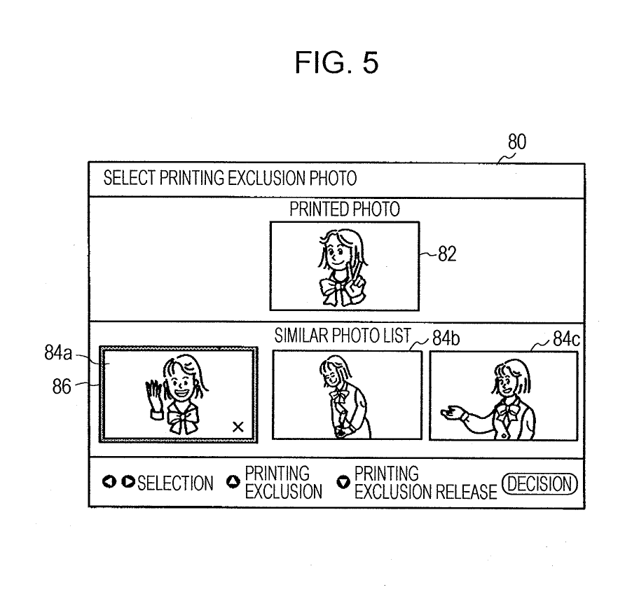

Returning to the printing process routine, when similar photos are present as the result of executing the similar photo searching process (step S190), a photo, which is not registered, out of the similar photos is registered in a printing exclusion candidate list as a candidate excluded from selection when a photo printed next time is selected (steps S200 and S210), and the contents of the similar photo list is cleared (step S220). Then, it is determined whether or not a print waiting photo is present in the printing list so as to determine whether or not the printing is completed (step s230). When the print waiting photo is present, the process returns to step S150, only the next print waiting photo is read, and the processes of steps S160 to S220 are repeated. When it is determined that the printing is completed, files registered in the printing exclusion candidate list are read (step S240), a printing exclusion selection screen is displayed and the selection of the photo is received from the user (step S250). FIG. 5 shows an example of the printing exclusion selection screen 80. In the printing exclusion selection screen 80, as shown in FIG. 5, a thumbnail image 82 is arranged on the upper side and thumbnail images 84a to 84c which are determined to be similar to the printed photo are arranged on the lower side. In the present embodiment, a photo can be selected by operating the left and right keys of the arrow keys 56 so as to move the position of the cursor 86. When a photo is selected, a similar photo selected by pressing the up key of the arrow keys 56 is set to printing exclusion (a mark “x” is put on the lower right of the photo in the drawing), and the setting of the printing exclusion may be released by pressing the down key of the arrow keys 56 with respect to the similar photo set to the printing exclusion. In addition, when the left key of the arrows keys 56 is pressed in a state in which the cursor 74 is positioned on the left end, preceding three new thumbnail images are displayed and, when the right key of the arrow keys 56 is pressed in a state in which the cursor 74 is positioned on the lower right, three new thumbnail images are displayed next. When any one of the similar photos registered in the printing exclusion candidate list is selected by the user, the file name of the selected photo is registered in the printing exclusion list (step S270) and the present routine is completed. In addition, the printing completion list, the printing exclusion candidate list, and the printing exclusion list may be newly prepared whenever the printing process routine is executed or the preceding list may be overwritten. In the former case, a plurality of lists may be present. As for the printing exclusion candidate list, if the printing completion list is present, since the printing exclusion candidate can be generated at any time by executing the similar photo searching process based on the files of the printing completion list, the printing exclusion candidate list may not be provided.

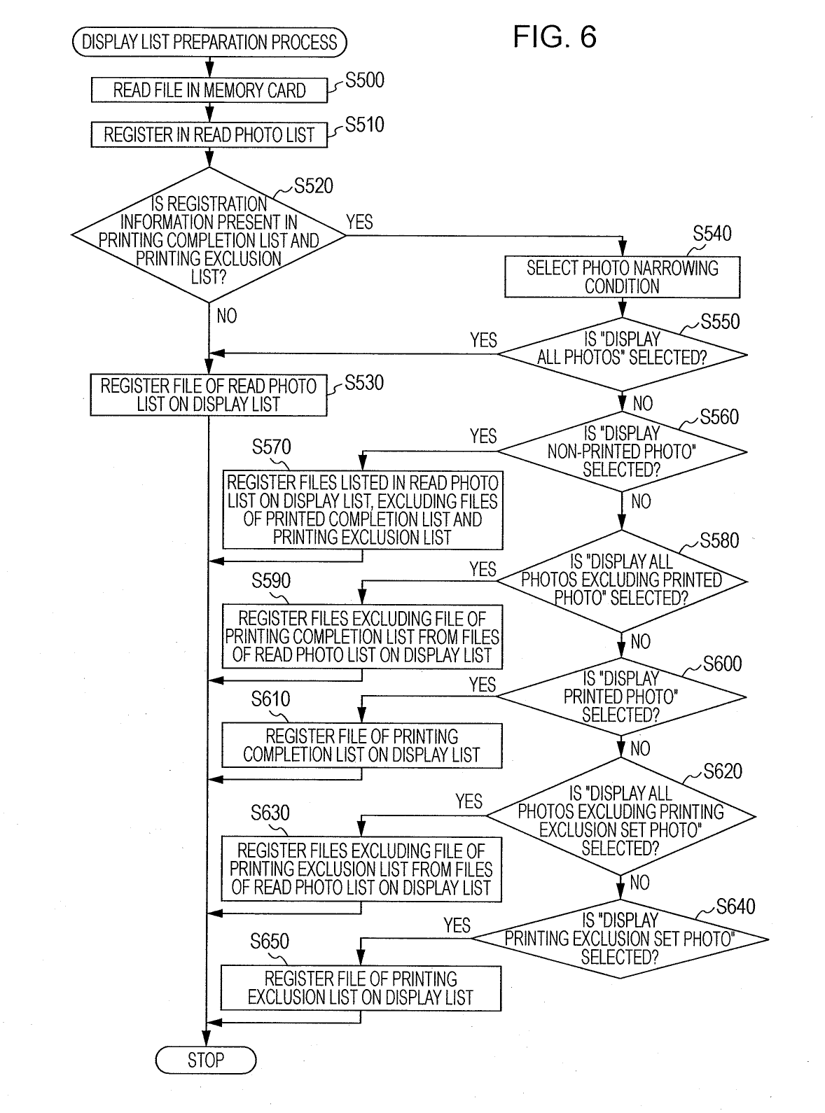

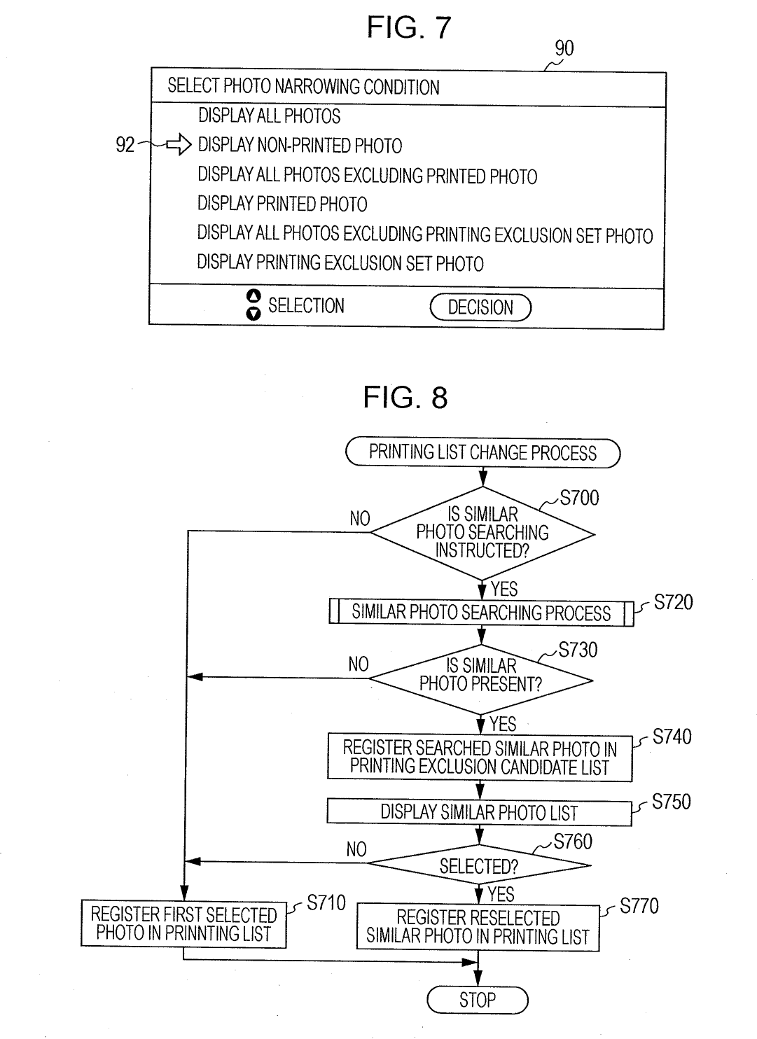

Next, the print list preparation process will be described. FIG. 6 is a flowchart showing an example of a display list preparation process executed by the main controller 60. In the print list preparation process, first, all the files stored in the memory card 42 are read (step S500), and the file names of the read files are registered in a read photo list (step S510). Subsequently, the printing completion list and the printing exclusion list are examined so as to determine whether or not registered information is present in such a list (step S520). When the registered information is not present in the printing completion list or the printing exclusion list, the file names of the read photo list are registered in a display list (step S530), and the present process is completed. In contrast, when the registered information is present in the printing completion list or the printing exclusion list, a photo narrowing condition is selected (step S540). This process is to select a condition for narrowing down the photos, which are thumbnail-displayed as a list on the photo selection screen of step S110 of the above-described printing process routine, among the photos stored in the memory card 42, and is performed using a narrowing condition selection screen 90 shown in FIG. 7. In this narrowing condition selection screen 90, in the present embodiment, as shown in FIG. 7, the narrowing condition includes “display all photos”, “display non-printed photo”, “display all photos excluding printed photo”, “display printed photo”, “display all photos excluding printing exclusion set photo”, “display printing exclusion set photo” and the like, any one of which can be selected by pressing a decision button in a state in which an arrow cursor 92 is placed on a desired item of the above-described items. The file names of all the files of the read photo list are registered in the display list (step S530) when the user selects “display all photos” (step S550), the file names of the files excluding the files of the printing completion list and the files of the printing exclusion list from all the files of the read photo list are registered in the display list (step S570) when “display non-printed photo” is selected (step S560), the file names of the files excluding the files of the printing completion list from all the files of the read photo list are registered in the display list (step S590) when “display all photos excluding printed photo” is selected (step S580), the file names of all the files of the printing completion list are registered in the display list (step S610) when “display printed photo” is selected (step S600), the file names of the files excluding the files of the printing exclusion list from all the files of the read photo list are registered in the display list (step S630) when “display all photos excluding printing exclusion set photo” is selected (step S620), and the file names of all the files of the printing exclusion list are registered in the display list (step S650) when “display printing exclusion set photo” is selected (step S640). Then, the present process is completed.

Now, the case where the user selects “non-printed photo” as the photo narrowing condition in step S540 of the display list preparation process is considered. In this case, only the files excluding the photos which are set by the user as the printing exclusion and the printed photos from all the files stored in the memory card 42 are displayed on the photo selection screen 70 in step S110 of the printing process routine, and printing is performed when the user selects a desired photo from the photos displayed on the photo selection screen 70. In the setting of the printing exclusion, as described above, since similar photos to the printed photo are automatically searched for whenever one photo is printed, a list thereof is displayed on the printing exclusion selection screen 80 as the printing exclusion candidate, and only a photo, which is selected by the user, out of the photos is set to the printing exclusion, an excessive burden is not laid on the user and a preliminary narrowing down is suitably performed when a photo to be printed is selected, compared with the case where the user sets the printing exclusion with respect to all photos one by one.

Now, the correspondence between the components of the present embodiment and the components of the invention will be described. The memory card 42 of the present embodiment corresponds to a “storage unit”, the display unit 52 as the liquid crystal display corresponds to a “display unit”, the main controller 60 for executing the processes of steps S180 to S220 of the printing process routine of FIG. 2 and the similar photo searching process of FIG. 4 corresponds to an “exclusion candidate image extracting unit”, the main controller 60 for executing the processes of steps S240 to S260 of the printing process routine corresponds to an “exclusion image selection reception unit”, the main controller 60 for executing the processes of step S270 of the printing process routine corresponds to an “exclusion image setting unit”, and the main controller 60 for executing the processes of steps S100 to S140 of the printing process routine and the display list preparation process of FIG. 6 corresponds to an “formed image selection reception unit”.

According to the multifunction printer 10 of the present embodiment, when printing is instructed along with the selection of a photo by the user using the photo selection screen, the printing process is executed with respect to the selected photo, similar photos to the printed photo are automatically searched for, a list of the searched similar photos is displayed as the printing exclusion candidate which is the candidate excluded from the selection when the searched similar photo which will be printed next time is selected, and a photo, which is selected by the user, out of the printing exclusion candidates is set to the printing exclusion such that this setting is applied to a next photo selection screen. Accordingly, the preliminary narrowing when a photo which will be printed next time is selected can be performed without laying an excessive burden on the user. In addition, since the narrowing down condition includes a plurality of conditions including “display all photos”, “display non-printed photo”, “display all photos excluding printed photo”, “display printed photo”, “display all photos excluding printing exclusion set photo”, “display printing exclusion set photo” and the like, it is possible to further increase the degree of freedom in the selection of the user.

According to the multifunction printer 10 of the present embodiment, since the similar photos to the printed photo are automatically searched for whenever one photo is printed, the printing exclusion candidates are prepared, and the selection of the printing exclusion photos is received from the user, it is possible to sequentially set the printing exclusion from the printed photo without waiting for the printing completion of all the photos.

Although the photo selected by the user is printed using the photo selection screen 70 displayed in step S110 of the printing process routine in the present embodiment, the invention is not limited thereto, and the similar photos to the photo, which is first selected by the user, may be automatically searched for using the photo selection screen 70, a list thereof may be displayed, and a photo to be printed may be reselected from the list of similar photos. FIG. 8 is a flowchart showing an example of a print list changing process. This routine is executed instead of the process of step S130 of the printing process routine of FIG. 2. In the print list preparation process, firstly, it is determined whether or not there is an instruction (similar photo searching instruction) for searching for the similar photos to a photo selected by the user (step S700). When there is not similar photo searching instruction, the photo which is first selected in step S120 of the printing process routine is registered in the printing list (step S710) and the present process is completed. When there is a similar photo searching instruction, the similar photo searching process of FIG. 4 for searching for the similar photos to the photo which is first selected is executed (step S720). When the similar photos are present in the searching result (step S730), the searched similar photos are registered in the printing exclusion candidate list (step S740), the list thereof is displayed on a similar photo display screen thereof and the reselection of a photo from the list of similar photos by the user is received (step S750), the reselected photo is registered in the printing list instead of the photo which is first selected (step S770) when the reselection is performed (step S760), and the present process is completed. In addition, when it is determined there is no similar photo in step S730 or when the reselection of the similar photo is not performed in step S760, the photo which is first selected is registered in the printing list (step S710) and the present process is completed. Accordingly, it is possible to reselect a similar photo better than the photo which is first selected by the user, without laying a burden on the user. By executing the similar photo searching process with respect to the photo selected by the user, the similar photos searched for in this step can be registered in the printing exclusion candidate list and can be set to the printing exclusion when a photo is selected and printed next time. As a result, it is possible to perform an efficient process. In this case, steps S180 to S220 of the printing process routine of FIG. 2 may be omitted.

Although, in the present embodiment, “display all photos”, “display all photos excluding printed photo”, “display printed photo”, “display all photos excluding printing exclusion set photo”, “display printing exclusion set photo” are used as the narrowing down condition in addition to the condition “display non-printed photo” for displaying the files excluding the printed files and the printing exclusion set files from all the files stored in the memory card 42 on the photo selection screen 70, some or all of “display all photos”, “display all photos excluding printed photo”, “display printed photo”, “display all photos excluding printing exclusion set photo”, “display printing exclusion set photo” may not be used. A condition for displaying the files excluding the printed files and the files registered in the printing exclusion candidate list from all the files stored in the memory card 42 may be added as the narrowing condition.

Although, in the present embodiment, when a plurality of photos is selected, in the printing process routine, the similar photos to the printed photo are automatically searched for by the processes of steps S180 to S210 whenever one photo is printed, the printing exclusion candidate list is prepared, and the selection of the printing exclusion photo by the user from the files of the printing exclusion candidate list is received, a plurality of printed photos at a timing after step S230 of completing all the photos may be collected, similar photos thereof may be automatically searched for, the printing exclusion candidate list may be prepared, and the selection of the printing exclusion photos by the user from the files of the printing exclusion candidate list may be collected and received.

Although, in the present embodiment, it is determined whether or not the comparison source photo and the photo to be compared are similar, by determining whether or not the file of the photo to be compared is photographed within ±the predetermined time of the file of the comparison source photo, whether both the comparison source photo and the photo to be compared are the photos of people and the number of persons is coincident, or whether the difference between the average of the gradation values of RGB of all the pixels configuring the comparison source photo and the average of the gradation values of RGB of all the pixels configuring the photo to be compared is within the predetermined ratio, any one or two of the three determinations may be omitted. In addition to these determinations, other similar determination processes may be executed.

Although the image processing apparatus of the invention is applied to the multifunction printer 10 including the printer unit 20 and the scanner unit 30 in the present embodiment, the invention is applicable to a printer without a copy function. The invention is not limited to an ink jet type printer, and may be applied to a laser printer using a toner as a coloring agent, a thermal transfer type printer, or a printing apparatus such as a FAX machine or a copier. The invention is not limited to the printer and may be applied to any apparatus which can be connected to a storage device for storing a plurality of image data, such as a personal computer, a digital camera, a digital video device, a mobile telephone or a photo viewer, and can form an image using image data selected by the user from the plurality of image data stored in the storage device.

Although the image forming apparatus of the invention is described in the present embodiment, a program for allowing one or a plurality of computers to function as the image forming apparatus may be implemented.

Although the embodiment of the invention is described, the invention is not limited to the above-described embodiment and may be variously implemented without departing from the technical range of the invention.

What is claimed is:

1. An image forming apparatus which is connected to a storage unit for storing a plurality of image data so as to form an image using image data selected by a user from the plurality of image data stored in the storage unit, the image forming apparatus comprising:
a display unit which displays a screen;
an exclusion candidate image extracting unit which extracts exclusion candidate image data as a candidate excluded from image formation with a predetermined condition from image-formed image data out of the image data stored in the storage unit;
an exclusion image selection reception unit which displays the extracted exclusion candidate image data by the display unit and receives selection of image data excluded from image formation by the user;
an exclusion image setting unit which sets the selected image data as exclusion image data excluded from image formation; and
a formed image selection reception unit which displays image data excluding the image-formed image data and the set exclusion image data from the plurality of image data stored in the storage unit on the display unit and receives selection of image data for image formation by the user, when an image forming instruction is received from the user.

2. The image forming apparatus according to claim 1, wherein:
a plurality of image data is collected and selected from the plurality of image data stored in the storage unit and image formation can be performed using the selected plurality of image data, and
the exclusion candidate image extracting unit and the exclusion image selection reception unit are performed with respect to the image-formed image data whenever image formation is completed with respect to one image data.

3. The image forming apparatus according to claim 1, wherein:
a plurality of image data is collected and selected from the plurality of image data stored in the storage unit and image formation can be performed using the selected plurality of image data, and
the exclusion candidate image extracting unit and the exclusion image selection reception unit are performed with respect to the image-formed image data after image formation is completed with respect to all the selected image data.

4. The image forming apparatus according to claim 1, wherein the formed image selection reception unit is able to extract image data coincident with the selected image data in the predetermined condition from the image data stored in the storage unit, to display the extracted image data on the display unit, and to change the selection from the selected image data to the extracted image data, before selection is decided, even when image data is selected by the user.

5. The image forming apparatus according to claim 4, wherein the exclusion candidate image extracting unit uses data which is extracted as image data coincident with the selected image data in the predetermined condition as the exclusion candidate image data.

6. The image forming apparatus according to claim 1, wherein the formed image selection reception unit is able to select at least one of the display of all the image data stored in the storage unit, the display of the image data excluding only the image-formed image data, the display of the image data excluding only the set exclusion image data, the display only the image-formed image data, and the display of the exclusion image data.

7. The image forming apparatus according to claim 1, wherein the predetermined condition is a condition similar to the image-formed image data.

8. The image forming apparatus according to claim 1, wherein the image forming apparatus is constituted as a printing apparatus for performing printing using the selected image data.

9. A program for allowing one or a plurality of computers to function as the image forming apparatus according to claim 1.
